(19) United States
(12) Patent Application Publication
(10) Pub. No.: US 2021/0379443 A1
(43) Pub. Date: Dec. 9, 2021

(54) Protective Cover for exercise equipment

(71) Applicant: James W White, III, Washington, DC (US)

(72) Inventor: James W White, III, Washington, DC (US)

(73) Assignee: James W White III, Washington, DC (US)

(21) Appl. No.: 16/892,185

(22) Filed: Jun. 3, 2020

(51) Int. Cl. A63B 21/00; B32B 5/24; B32B 27/34; B32B 27/12

(52) U.S. Cl. CPC A63B 21/4037; B32B 5/24; B32B 27/34; B32B 2262/062; B32B 2307/726; B32B 2262/0261; B32B 27/12

(57) ABSTRACT

The invention is directed to a protective cover for exercise equipment. The cover is of two ply construction and is comprised of an upper layer manufactured from a soft, absorbent fabric material such as terrycloth, and a bottom layer which is manufactured from a water-resistant material such as nylon fabric. The cover is easily secured to the corners of a weightlifting bench or similar surface, with nylon drawstrings, elastic cords, hook-and-loop fasteners, or some similar type of fastener. Preferably, the upper layer is removable for laundering purposes.

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to weightlifting accessories, and in particular to a protective cover for exercise equipment Perspiration from the head and the body can be annoying, particularly for those who are engaged in a weightlifting or machine exercise regimen. The perspiration problem is even worse when multiple people are using the equipment, such as at a health club or college gymnasium. The transfer of body fluids of any type has been cause for serious and legitimate health concerns. If the perspiration is fresh and damp, it is possible that a virus could be contracted, particularly in exercise positions where the user is face down on the bench. A cover which prevents any body fluids from contacting the bench, and is removed and replaced before the next user lays down on the bench, would be well received. A protective cover for exercise equipment, which is secured to the bench with drawstrings or hook-and-loop fasteners and effectively absorbs perspiration and neutralizes odor, would resolve these problems.

### SUMMARY OF THE INVENTION

Accordingly, the invention is directed to a protective cover for exercise equipment. The cover is of two ply constructions and is comprised of an upper layer manufactured from a soft, absorbent fabric material such as terrycloth, and a bottom layer which is manufactured from a water-resistant material such as nylon fabric. The cover is easily secured to the corners of a weightlifting bench or similar surface, with nylon drawstrings, elastic cords, hook-and-loop fasteners, or some similar type of fastener. Preferably, the upper layer is removable for laundering purposes.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a top view of the first exemplary embodiment, displaying the cover 10, the upper layer 11, the trim 13, and the drawstring 14.

FIG. 2 is a bottom view of the first exemplary embodiment, displaying the cover 10, the bottom layer 12, the trim 13, and the drawstring 14.

FIG. 3 is a top perspective view of the first exemplary embodiment, displaying the cover 10, the upper layer 11, the trim 13, and the drawstring 14.

FIG. 4 is a side perspective view of the first exemplary embodiment, displaying the cover 10, the upper layer 11, the trim 13, and the drawstring 14.

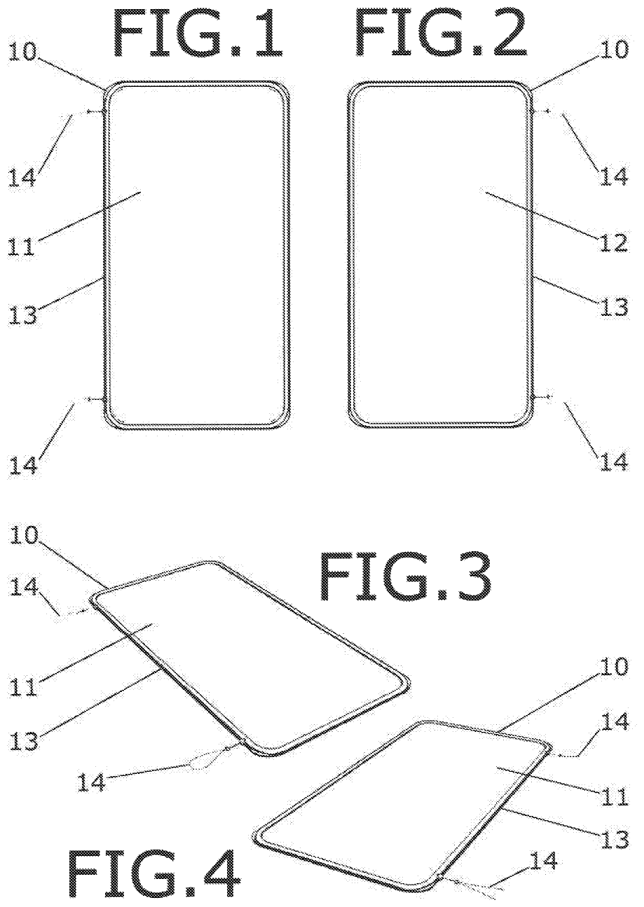

### DETAILED DESCRIPTION OF THE INVENTION

Referring now to the invention in more detail, the invention is directed to a protective cover 10 for exercise equipment.

The first exemplary embodiment is comprised of a two-ply cover 10, which is of a rectangular shape with rounded corners, slightly larger than the top surface of a weightlifting bench. The cover 10 provides an upper layer 11 manufactured from a soft, absorbent fabric material such as terrycloth, and a bottom layer 12 which is manufactured from a water-resistant material such as nylon fabric. The top layer 11 and the bottom layer 12 are temporarily affixed together by trim 13 which extends around the perimeter of the cover 10. The trim 13 provides a concealed zipper which may be used to separate the top layer 11, such that it may be laundered. The trim 13 further provides a nylon drawstring 14, which may be used to secure the cover 10 to the top surface of the weightlifting bench.

The upper layer 11 is intended to absorb perspiration and any other body fluids from the user, and provide a soft, comfortable surface for the user to lay on during a workout The bottom layer 12 is intended to prevent any body fluids from seeping through from the top layer 11 to the bench surface.

It is to be understood that while the first exemplary embodiment is intended for use with a weightlifting bench, this is not intended as a limitation. With suitable modifications or with no modifications at all, alternate versions of the invention may be used with any type of exercise equipment which provides a surface, upon which the user sits or lays down. A wide variety of sizes and shapes are provided to fit any type of exercise equipment. Alternate embodiments, wherein the upper layer 11 and the bottom layer 12 are permanently affixed, and the trim 13 provides heavy duty stitching, are contemplated. Other alternate embodiments, wherein elastic cords or bands, hook-and-loop fastener strips, or some similar type of fastener is provided instead of a drawstring 14, are also contemplated.

To use the first exemplary embodiment, the user places the cover 10 over the top surface of the bench and secures the cover 10, using the drawstring 14 which is provided, such that the rounded corners of the cover 10 are tucked under the corners of the bench. The user then lays down on the bench and exercises. When finished with exercising, the user may remove the cover 10 from the bench by loosening the drawstring 14.

The upper layer 11 and the trim 13 are preferably manufactured from a flexible, durable fabric which is highly absorbent and machine washable, such as terrycloth, a cotton-polyester blend, or a cotton-rayon blend. The bottom layer 12 is preferably manufactured from a flexible, durable material, such as nylon fabric.

The drawstring 14 is preferably manufactured from a flexible, durable material which provides substantial tensile strength, such as nylon cord. The zipper is preferably manufactured from a rigid, durable material such as brass, stainless steel, or aluminum alloy. Components and methods listed above are preferable, but artisans will recognize that alternate components and methods could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

1. An Apparatus comprising of two layered materials to provide a two-ply protective cover that prevents contact between exercise equipment, the user and any laden germs, viruses or bodily fluids.

2. An Apparatus according to claim 1 where in a top layer manufactured from a soft absorbent fabric such as Terry Cloth prevents the equipment user from transferring their body fluids on equipment.

3. An Apparatus according to claim 2 where in a bottom layer manufactured from a moisture resistant flexible material such as Nylon prevents gem contact or fluid seepage onto top layer and equipment user.

4. An Apparatus according to claim 3 where in a trim is stitched into the top layer providing a channel along the perimeter of said cover.

5. An Apparatus according to claim 4 where in a drawstring comprised of nylon or elastic cord is encased inside the trim to allow the cover to adjust to fit most exercise equipment.

6. An Apparatus according to claim 5 where in a metal or plastic zipper is attached to bottom layer along the trim allowing for detachment from top layer for laundering.
